(19) United States
(12) Patent Application Publication
(10) Pub. No.: US 2020/0355724 A1
(43) Pub. Date: Nov. 12, 2020

(54) SYSTEM AND METHOD FOR OPTICAL DRIFT CORRECTION

(71) Applicant: MOLECULAR VISTA, INC., San Jose, CA (US)

(72) Inventors: Kyle C. JUEDES, Sherwood, OR (US); Thomas R. ALBRECHT, San Jose, CA (US); Derek NOWAK, San Jose, CA (US); Sung PARK, Saratoga, CA (US)

(73) Assignee: Molecular Vista, Inc., San JoseT, CA (US)

(21) Appl. No.: 16/095,681

(22) PCT Filed: Apr. 21, 2017
(86) PCT No.: PCT/US2017/029006

§ 371 Date: Oct. 22, 2018

Related U.S. Application Data
(60) Provisional application No. 62/325,832, filed on Apr. 21, 2016.

(51) Int. Cl. G01Q 70/04; G01Q 20/02; G02B 27/64

(52) U.S. Cl. CPC G01Q 70/04; G02B 27/646; G01Q 20/02

(57) ABSTRACT

System and method for optical drift correction uses light from a light source that is reflected from a curved surface of a mirror and detected at photosensitive detectors to detect movements of the mirror with respect to the light source.

### CROSS-REFERENCE TO RELATED APPLICATION

This application is entitled to the benefit of provisional U.S. Patent Application Ser. No. 62/325,832, filed Apr. 21, 2016, which is incorporated herein by reference.

### BACKGROUND

Atomic Force Microscopy (AFM) affords the opportunity for conducting nanoscale experiments involving extremely high meteorological precision. These measurements are inherently plagued by complex and unpredictable thermal drift of mechanical components used in the microscope, resulting in a relative motion between the imaging tip and the sample. From simple image analysis, it can be difficult to discriminate between this drift and real feature positioning on the sample. The precision of the measurement instrument is therefore severely impaired.

### SUMMARY

System and method for optical drift correction uses light from a light source that is reflected from a curved surface of a mirror and detected at photosensitive detectors to detect movements of the mirror with respect to the light source

An optical drift correction system in accordance with an embodiment of the invention includes a mirror with a curved surface, a light source positioned to transmit light onto the curved surface of the mirror, a plurality of photosensitive detectors positioned to receive the light reflected from the curved surface of the mirror, and a detection circuitry electrically connected to the photosensitive detectors to process signals from the photosensitive detectors to detect movements of the mirror with respect to the light source.

An atomic force microscope in accordance with an embodiment of the invention includes a cantilever with a tip to engage a sample, a scanner platform to place the sample, and an optical drift correction system coupled to the scanner platform. The optical drift correction system includes a mirror with a curved surface, a plurality of photosensitive detectors positioned to receive light reflected from the curved surface of the mirror, and a detection circuitry electrically connected to the photosensitive detectors to process signals from the photosensitive detectors to detect movements of the mirror.

A method for optical drift correction in accordance with an embodiment of the invention includes transmitting light from a light source onto a curved surface of a mirror, receiving the light reflected from the curved surface of the mirror at a plurality of photosensitive detectors, generating signals by the photosensitive detectors in response the received light, and processing the signals from the photosensitive detectors at a detection circuitry to detect movements of the mirror with respect to the light source.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 illustrates the characteristic reflection of an optical ray from a curved target mirror, which is the basis for a drift correction sensor according to embodiments of the invention.

FIG. 2 illustrates a ray-trace description of light made to be collimated, divergent or convergent that can be used in a drift correction sensor according to embodiments of the invention.

FIG. 3 illustrates an optical arrangement for a drift correction sensor according to an embodiment of the invention.

FIG. 4 illustrates an optical arrangement for a drift correction sensor without Z-coupling according to an embodiment of the invention.

FIG. 5 illustrates a revised optical arrangement for a drift correction sensor without Z-coupling for increased efficiency and back-reflection reduction according to an embodiment of the invention.

FIG. 6 illustrates a detection circuitry of a drift correction sensor according to an embodiment of the invention.

FIG. 7 illustrates a normalization circuit that can be used in the detection circuitry of a drift correction sensor according to an embodiment of the invention.

FIGS. 8A-8E show an arrangement of a drift correction sensor magnetically attached to a sample holder of a scanner stage of an atomic force microscope (AFM) in accordance with an embodiment of the invention.

FIGS. 9-12 show how the optical drift correction sensor is integrated into an AFM head and how the AFM head is integrated into a complete AFM in accordance with an embodiment of the invention.

FIG. 13 illustrates two optical drift sensors on opposite sides of a sample location in accordance with an embodiment of the invention.

FIG. 14 is a flow diagram of a method for optical drift correction in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. Merely as an example, aspects that will be described as being applied to a virtual machine network can be similarly applied in the display of information regarding physical computers/machines. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

Disclosed herein is a sensor design that effectively measures thermal drift of different components. Used in an atomic force microscope, the described sensor design can effectively measure thermal drift between the tip of the microscope and the sample being imaged by the microscope and actively corrects for it with sub-nanometer resolution.

Conventional solutions to thermal drift include using capacitive sensors and interferometer-based drift correction. Capacitive sensors or interferometer-based drift correction can certainly achieve the resolution required, but it is difficult to place them within millimeters of the tip-sample interaction. Sensor proximity to the tip is an absolute requirement for comprehensive drift correction. Embodiments of the invention described herein can use an almost arbitrarily small laser beam and mirror, allowing it to be placed very near the tip without obstructing instrument functionality. Further, the small size of the individual constituents of the sensor according to embodiments of the invention ensures that it does not contribute significant drift itself. The described techniques also achieve an adjustable sensitivity, allowing for drift tracking over a high dynamic range. This also accommodates a certain ease and automation of alignment. Alternatively, for small scans, the resolution can be made to be very high. These characteristics are not present in other sensor designs.

When comparing to other techniques, such as drift correction obtained from feature tracking over a set of images, the sensor according to embodiments of the invention maintains some advantages. First, the noise is low enough that one can use a high bandwidth for real-time drift correction without having to wait long between measurements, such as the time it takes to complete several images. This makes measurements using the sensor as free from residual error as possible. Also the techniques described herein are not subject to the inconveniences of tracking errors and tip convolution that can make accurately measuring drift to sub-nanometer resolution difficult. Finally, the described techniques work well in many scanning probe sample environments. These include those which may involve very small scans over smooth surfaces without distinguishable features to compare between images. Some experiments also require keeping the tip to be on top of a specific point in sample for prolonged measurements without any scanning motion.

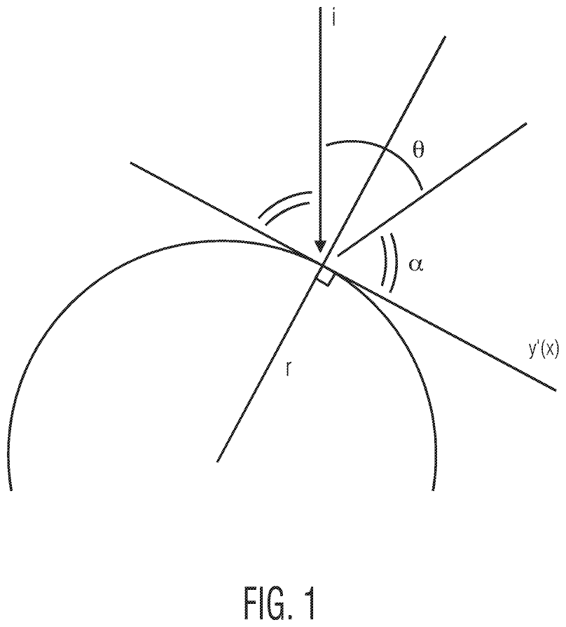

The drift correction sensor according to embodiments of the invention is based upon the characteristic reflection of an optical ray from a curved target mirror. The mirror is allowed to drift, or move horizontally, inducing a trajectorial perturbation in the reflected ray. This principle is illustrated in FIG. 1, which shows a ray, i, to be incident upon a convex surface S, such as a spherical, cylindrical, or parabolic surface, of effective local radius r, resulting in a reflection angle, θ. The perturbation is a function of the radius of the sphere and the horizontal displacement from the center of the sphere, x. The sensor can be designed with either a convex mirror (shown) or a concave mirror, as the reflection principles remain the same.

To create a positional sensor, the reflected laser beam is made incident upon a position sensitive photodetector. One embodiment for this application is a quadrant photodiode, allowing for the creation of an electrical signal that is proportional to the motion of the mirror. When plotted against the displacement, x, this is shown to give a linear signal response, provided the displacement is a reasonably small fraction of the sphere radius, r:

$$Signal ( x ) ∝ \frac{{L}_{p} {D}_{d} \cdot Tan ( π - 2 \cdot Arctan ( \frac{\sqrt{{r}^{2} - {x}^{2}}}{x} )}{{S}_{s}} ,$$

where:
Signal(x): Sensor Output Signal (arbitrary units)
Lₚ: Laser Power (arbitrary units)
D_{d}: Distance to Detector Power (mm)
r: Radius of Spherical Mirror (mm)
x: Horizontal Displacement from Center of Sphere
Sₛ: Reflected Beam Spot Size on Detector (arbitrary units)

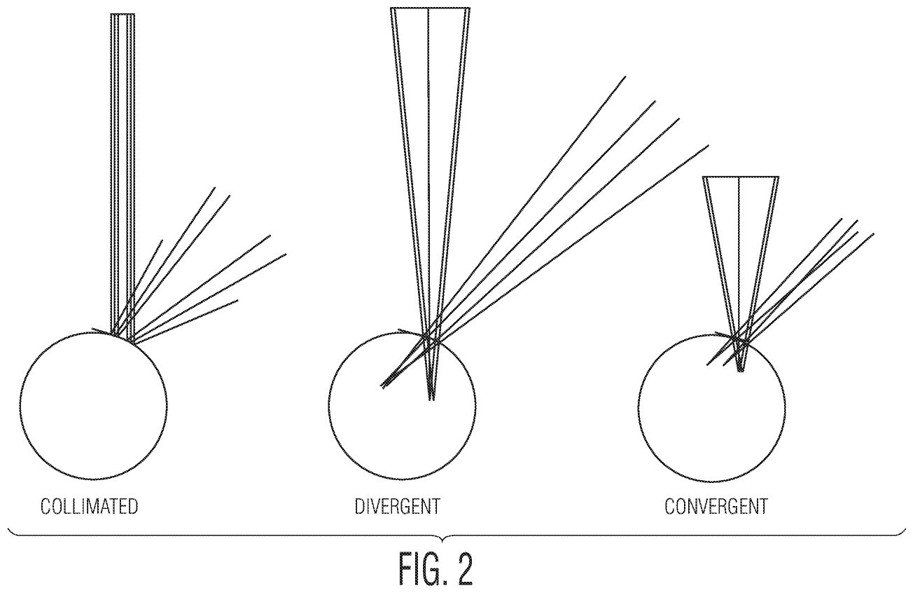

In a practical sensor design, a combination of an optical source and lens will be required to approximate the optical ray used in the theoretical discussion. Three variations are possible, wherein the light can be made to be collimated, divergent or convergent. Each variation alters the sensitivity of the sensor, as the ultimate spot size on the detector, Sₛ, changes for a fixed D_{d}. An adjustable focus allows for an adjustable sensitivity, with a tight spot on the detector achieving the highest resolution, and a large spot achieving the largest mirror displacement dynamic range. FIG. 2 gives a ray-trace description of three cases. In each, the incident beam is translated a small amount, so the resultant beam translation on the detector (not shown) could be measured.

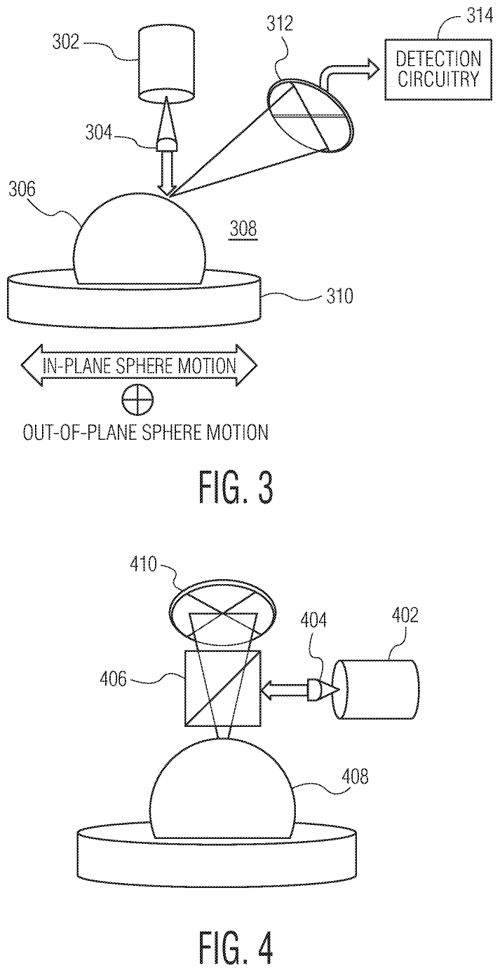

An optical arrangement described above is shown in FIG. 3, with a diode laser 302, which may be a radio frequency (RF) laser diode, and collimating lens 304 approximating an optical ray which is made to reflect obliquely from a spherical surface 306 of a mirror 308 on an X-Y translation stage 310, which may be 4-10 mm in diameter. Since the collimated width is nonzero, the collimated laser beam becomes divergent upon interacting with the sphere 308. The collimated beam could be adjusted by repositioning the focusing lens 304, creating a convergent or divergent incident beam and an altered sensitivity at a detector 312, which has multiple photosensitive elements or detectors. In the illustrated embodiment, the detector 310 is a quadrant photodiode (with four photosensitive elements) that is connected to a detection circuitry 314 for the T-B (Top quadrants minus Bottom quadrants) and L-R (left quadrants minus Right Quadrants) differential operations, yielding a sensor capable of detecting motion of the sphere in the in-plane (of the diagram) and out-of-plane directions. The detection circuitry 314 is capable of detecting a SUM (Top quadrants+Bottom quadrants) signal, useful for monitoring the stability of the laser 302.

Alternatively, the sensor mirror need not necessarily be spherical. A similar sensor can be imagined with a cylindrical mirror, offering uniaxial motion detection. The cylindrical mirror will introduce astigmatic divergence in one axis only. A cylindrical lens placed before or after the mirror could be used to re-symmetrize the beam. A pair of such uniaxial sensors used in concert, with the axis of each cylindrical mirror positioned 90 degrees apart would provide sensing along both X and Y, the same as the spherical mirror.

Although the terms “spherical” and “cylindrical” are used throughout this document to describe basic reflector configurations for this sensor, it should be noted that purely spherical and cylindrical reflectors necessarily create aberration in the reflected beam. Moreover, when a spherical reflector is used, this aberration may have different effects along the two axes of interest for sensing. For example, if a round beam is incident upon the sphere, the reflected beam may have unequal divergence or convergence along the two sensing axes. This results in a different sensitivity of detection along the two axes, which may be problematic. Furthermore, adjustment of a focusing lens in the incident beam may result in two separate focus points for the two axes of interest; this means that there is no single focus point that results in the smallest spot size on the detector for both axes. The focus can be adjusted for minimum spot size and maximum sensitivity along one axis, but the focus adjustment must be changed to minimize spot size along the other axis. In general, a round beam becomes elliptical, resulting in unequal sensitivity along the two axes.

One solution to the aberration problem arising from a spherical reflector is to replace the spherical reflector with an aspheric reflector, such as a convex parabolic reflector. Use of an aspheric reflector can eliminate spherical aberration, and allow for optimization of spot size and sensitivity along both axes simultaneously. Whenever “spherical” or “cylindrical” mirrors are mentioned in this document, it should be assumed that these can be replaced with aspheric or non-cylindrical reflectors, such as a parabolic surface of revolution or paraboloid (in place of a sphere) or an extruded parabolic surface (in place of a cylinder).

In both the case of the spherical and cylindrical mirrors with an oblique reflection, one of the two detection axes will be particularly coupled to Z-motion of the mirror. Since the sensor is designed for use in a scanning probe microscope with significant intentional Z-motion, this is very undesirable.

Fortunately, in a system according to embodiments of the invention, the sensor is mounted on a closed-loop scanning stage which allows for careful monitoring of motion in the Z direction. Even if this is not measured directly by a sensor, it can be extrapolated from the drive signal sent to Z-piezos. To remove the coupling to the sensor, one can first calculate the coupling extent by moving the stage up and down while monitoring the voltage generated in the vulnerable sensor axis. Once the coupling extent has been determined, for all subsequent Z stage motions a correction voltage is subtracted from the sensor output to nullify this effect.

Alternatively, if two separate sensors are used with two separate reflectors, each set so that one of two in plane axes can be measured without Z-motion coupling, then full X and Y sensing can take place without parasitic effects from Z-motion. For a given sensor, motion along an axis which causes horizontal motion of the beam on the detector will not be sensitive to Z-motion. Setting up two detectors such that one detects X-motion as horizontal beam deflection, and the other detects Y-motion as horizontal beam deflection, accomplishes this goal. Basically, this amounts to two identical sensors configured at right angles to one another.

Another option for elimination of Z-motion sensitivity is to illuminate and collect light from a normal incidence, i.e., directly above the center of the convex reflector. This allows for a compact design without Z-coupling, but is subject to strong back-reflection that may destabilize the optical source. A preliminary version is shown in FIG. 4. As shown in FIG. 4, a collimated laser beam using a light source 402 and collimating lens 404 enters the optical system from the right. A 50/50 beam splitter 406 directs half of the beam at a spherical target mirror 408. Half of the reflected beam is allowed to pass to a detector 410, which may be a quadrant photodiode, positioned above the beam splitter. This arrangement wastes a portion of the illuminating and reflected light, but is effective for normal illumination.

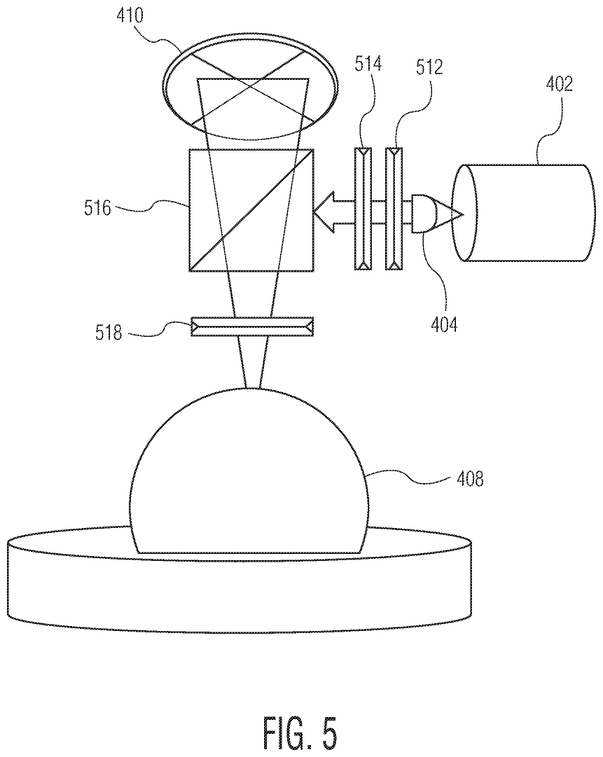

A revised sensor design is show in FIG. 5. In this sensor design, a collimated laser using the light source 402 and the collimating lens 404 enters the optical system from the right. A polarization film 512 and a half-wave plate 514 allow for power attenuation and polarization alignment of the laser beam. The alignment is set so that the laser beam is reflected downward upon interacting with a polarizing beam splitter 516. A quarter-wave plate 518 then circularizes the polarization of the laser beam. The beam is reflected from the target mirror 408, and upon passing through the wave plate 518 once more, the polarization is rotated 90 degrees. It is thus allowed to pass unimpeded through the beam splitter 516 and onto the detector 410 that is placed above. This design is more efficient and reduces back-reflections.

In these examples, the optical source has been a simple continuous wave (CW) diode laser. Several variations exist here. The laser diode may be RF modulated to reduce pointing noise. The laser intensity may be modulated and the signal at the quadrant photodiode may be demodulated by a lock-in amplifier to expunge 1/f noise. The laser diode may be replaced by a superluminescent diode. The laser diode may be replaced by a fiber coupled laser source far from the sensor. All of these are possible without any fundamental redesign of the sensor.

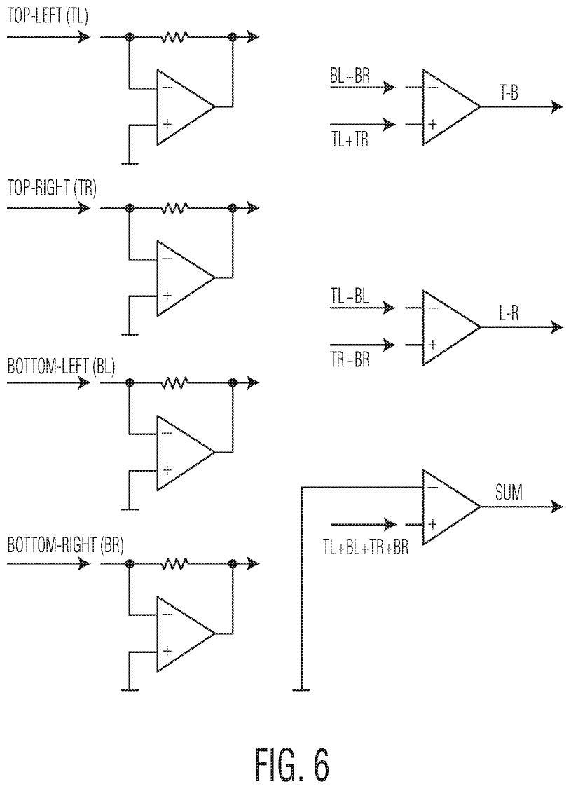

The detection circuitry of the sensor in accordance with an embodiment of the invention is shown schematically in FIG. 6. The four signals from the quadrant photodiode and a +5V bias enter the circuit on the left. Each quadrant signal enters a dedicated transimpedance amplifier and, subsequently, a series of differential or summing amplifiers that produce signals corresponding to T-B, L-R and SUM.

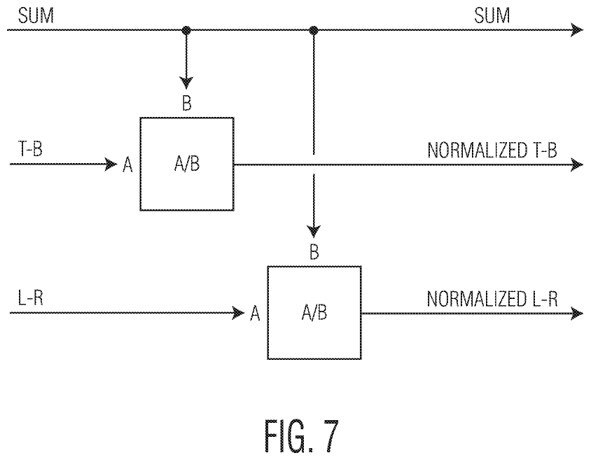

The sensor position outputs are directly subject to noise caused by intensity fluctuations in the optical source, regardless of which is chosen. A normalization circuit can be used to divide the sensor position outputs (T-B, L-R) by the SUM signal. This circuit does very well to improve sensor stability and noise, allowing the preservation of a high bandwidth for real-time drift tracking. The normalization circuit in accordance with an embodiment of the invention is shown in FIG. 7.

The sensor described above may be housed in a scanning probe microscope. In an AFM configuration, there is a shared requirement for a high stability optical source free of noise and drift. It is possible to use the same optical source for both the drift correction sensor and the beam deflection from the AFM cantilever. In this configuration, the optical source is collimated and then directed into a beam splitter. A separate focusing lens and detector are then used for both the drift correction and beam deflection sensor systems.

Since the objective is to track drift between the probe and the stage moving the sample, it is important to mount the sensor as closely as possible to the tip-sample interface. In a microscope consisting of a “head” housing the tip and a “scanner” responsible for generating closed-loop motion of the sample relative the tip, several mounting arrangements are possible. First is to mount the optical source, detector and conditioning optics in the head, while mounting the spherical or cylindrical mirrors to the scanner. Alternatively, the sensor can be inverted, with the mirror mounted to the head and the remaining components being mounted to, or within, the scanner. The components of the sensor itself can be made of materials with close thermal matches to their surroundings so that the sensor itself does not contribute significant drift.

Since the sensor has a limited dynamic range, it is necessary to provide a means of positioning the spherical mirror on the sample holder in the correct position below the light source and detector. Since the sample holder can typically be translated in an AFM by several millimeters or more, each time such a move is made, the mirror needs to be repositioned. Ideally, the mirror is positioned so that the sensor is centered (zeroed) within its dynamic range. A small two-dimensional translation stage can be used to move the spherical mirror to a position of alignment after the sample-tip position has been set. However, such a translation stage may be mechanically complex and introduce its own contributions to thermal drift. An alternative is to mount the spherical mirror on a magnetic holder that adheres to the sample stage, but can be readily repositioned simply by sliding along the magnetic planar surface of the sample holder. This provides for arbitrary X-Y positioning of mirror relative to the sample, allowing the sensor to be re-zeroed each time the sample position is moved by sliding the mirror holder. Once it is in the proper position, the magnetic force holding the mirror holder to the sample stage is sufficient to keep the relative position of the sample and mirror fixed while scanning.

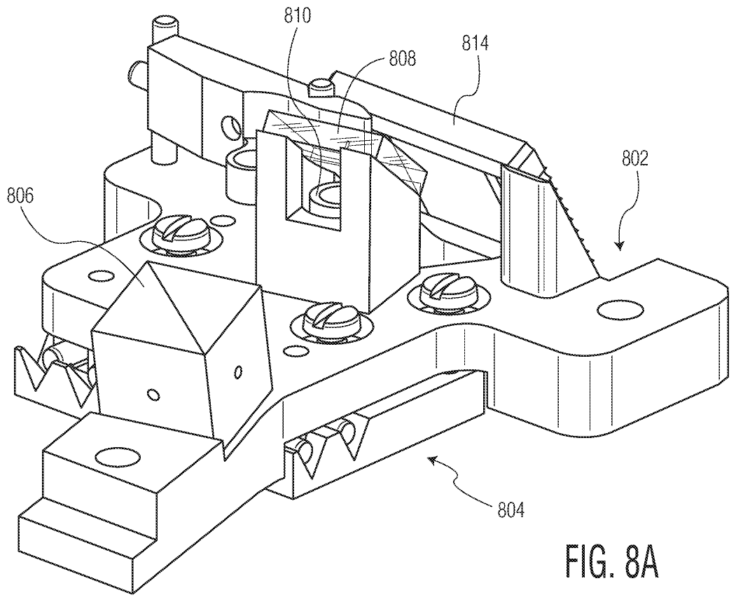

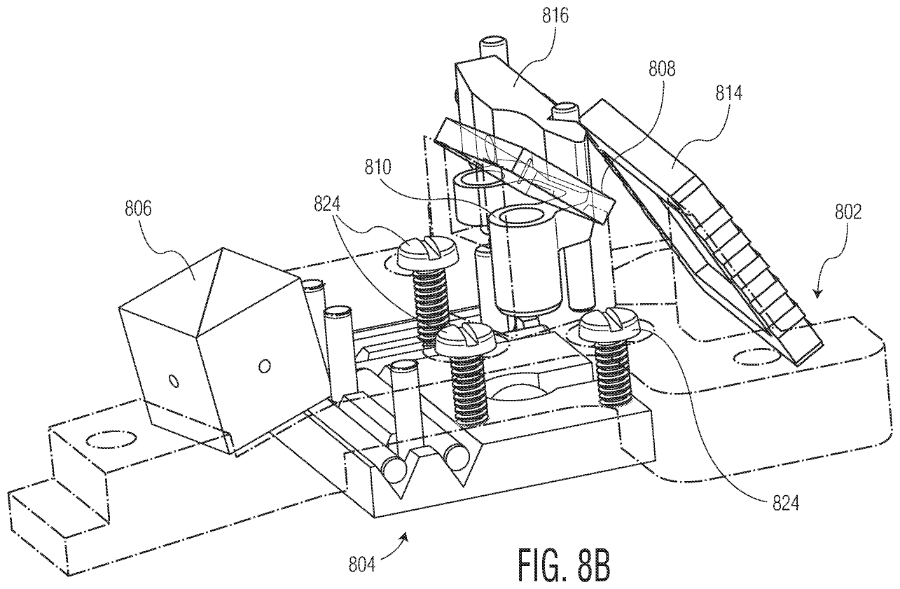

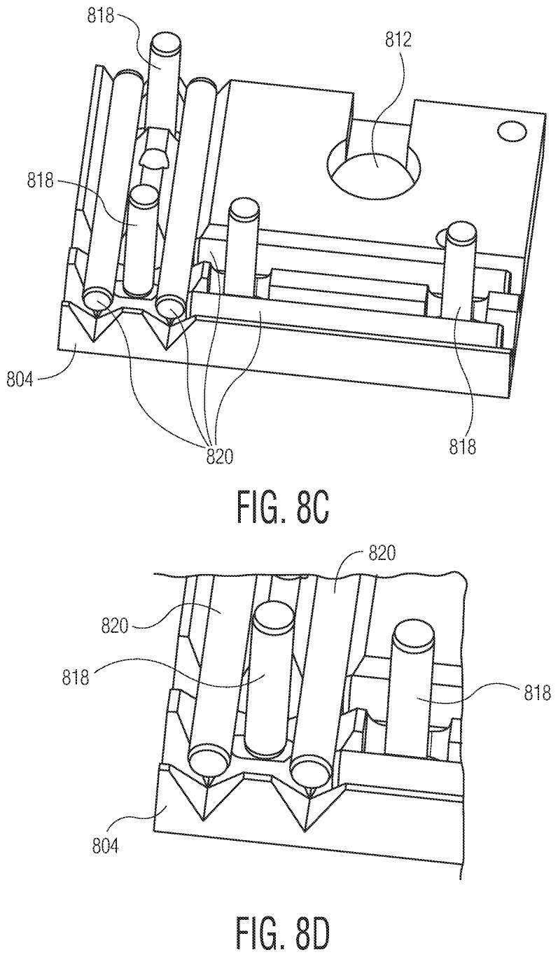

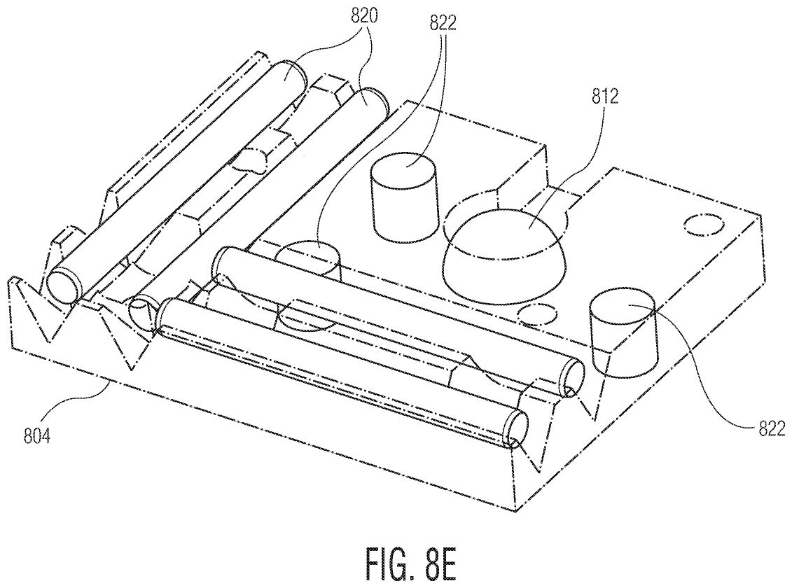

A particularly advantageous approach for sliding the mirror holder with respect to the sample stage is to provide pushers, which may be shaped in the form of rods or other appropriate shapes, on the microscope head which remains fixed while the sample position is moved. These rods contact bumpers on the mirror holder, thereby sliding the mirror holder along the sample holder surface whenever the sample is moved. Such an arrangement is shown in FIGS. 8A, 8B, 8C, 8D and 8E.

FIG. 8A shows two bodies: the optical drift correction sensor (ODC) frame 802, which is rigidly attached to the AFM head (not shown), and a mirror holder 804 (referred to as the ODC “puck”) which is magnetically attached to the sample holder on the scanner stage of the microscope. The frame 802 has a beam splitter 806 which divides light from a single source between the AFM head's cantilever deflection sensing system (not shown) and the optical drift correction system. The light beam from the beam splitter 806 intended for the drift correction sensor reflects downward from a planar steering mirror 808, through a focusing lens 810 and to a spherical mirror 812 (shown in FIGS. 8B, 8C and 8D) on the puck 804. The beam reflected off the spherical mirror 812 is then collected by a quadrant photodiode.

FIG. 8B shows the internal parts of the frame 802, in particular highlighting a focusing mechanism 816 that allows the vertical position of the focusing lens 816 between the planar steering mirror 808 and the spherical mirror 812 to be adjusted. The focusing mechanism 816 is magnetically held against two steel pins fixed to the frame 802. An upward facing magnet on the focusing mechanism 816 sticks to the tip of a ball-end fine adjustment screw (not shown) that is threaded into the head. As the adjustment screw is turned, the focusing mechanism 816 slides up and down on its steel pins, raising and lowering the focusing lens 816, which in turn adjusts the sensitivity and dynamic range of the overall sensor.

FIGS. 8C and 8D show how the push rods 818 fixed to the frame 802 interact with the bumpers 820 on the puck 804. The push rods protrude into a gap between the bumpers. There are two push rods and two bumpers each for the X and Y directions. The gaps between the bumpers are larger than the diameter of the push rods so that the sample can be scanned over a limited range without contacting the bumpers, as best illustrated in FIG. 8D. Thus, the puck is slideably coupled to the sample holder on the scanner stage of the microscope. The magnets (shown in FIG. 8E) on the puck hold the puck (because of sliding friction) in a fixed position on the scanner stage when the push rods are not in contact with the bumpers. When a push rod pushes on a bumper, however, the friction holding the position of the puck fixed relative to the scanner stage is overcome, and the pushers may thereby slide the puck to a new position on the scanner stage. This arrangement results in a particular amount of backlash when pushing the position of the puck relative to the sample using the push rods fixed to the head. This backlash allows the puck to be contacted by the push rods when there is a need to move the puck relative to the sample, and then to back off into the open gap to allow contact-free scanning, which is essential to avoid disturbing the fine motion of the scanner.

FIG. 8E shows the internal members of the puck 804, including the magnets 822 which hold the puck to the sample platform on the scanner.

Note also the “pick-up” screws 824 shown in FIG. 8B. During scanning, there is no contact between the pick-up screws, which are rigidly attached to the puck 804, and the frame 802, which has clearance holes large enough to avoid contact when the push rods 818 are positioned within the gaps of the bumpers 820. When the entire head is removed from the scanner of the AFM, the pick-up screws “pick up” the puck from the scanner platform, keeping the puck with the head. When the head is returned to the scanner for use, the puck is automatically roughly positioned below the sensor, and sticks to the sample platform.

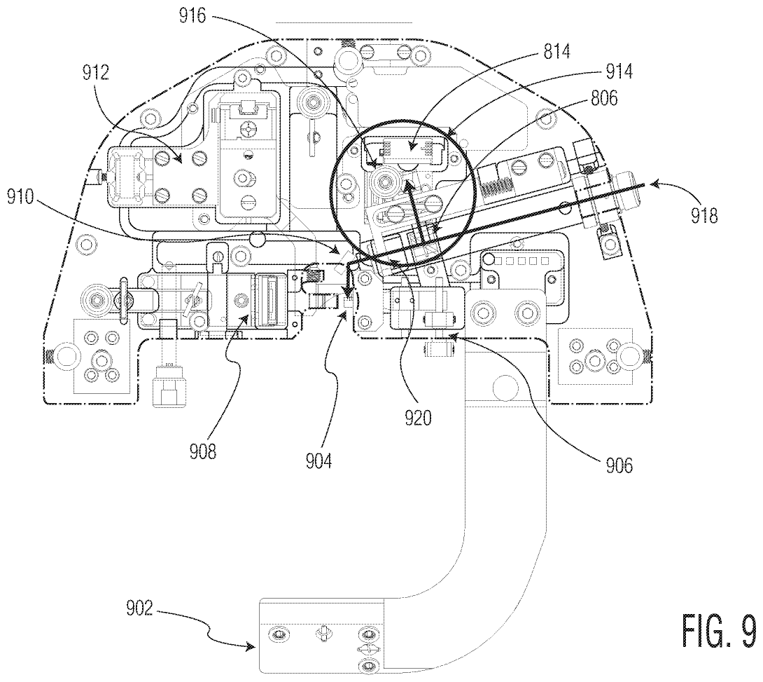

FIGS. 9-12 show how this ODC assembly is integrated into the AFM head, and how the AFM head is integrated into the complete AFM in accordance with an embodiment of the invention. FIG. 9 is a top view of the AFM head with the top covers removed, and the head body made transparent for viewing internal components. In FIG. 9, several subsystems within the AFM head are visible. This head is designed for photo-induced force microscopy, so it has various features beyond what is required for a conventional AFM head. FIG. 9 shows a front gimbaled steering mirror 902 for light path to parabolic mirror (on bottom), a cantilever and tip location 904 (on bottom), cantilever clamping mechanism 906, a photodetector 908 for cantilever deflection sensing, beam steering mirror and mechanism 910 for cantilever deflection sensing, translation stages 912 for parabolic mirror, an optical drift correction (ODC) sensor assembly 914, which includes an ODC focus adjust knob 916, the ODC photodetector 814, the ODC beam splitter 806, and other components described above with respect to FIGS. 8A-8E, a fiber coupled laser connection point 918 and focusing lens and adjustment mechanism 920 for cantilever deflection sensing.

In operation, laser light is coupled in through an optical fiber connection on the right. The laser beam is directed at the beam splitter 806 (part of the ODC as shown in FIG. 8A), where 50% of the light is directed towards the ODC system, and 50% toward the cantilever deflection sensing system.

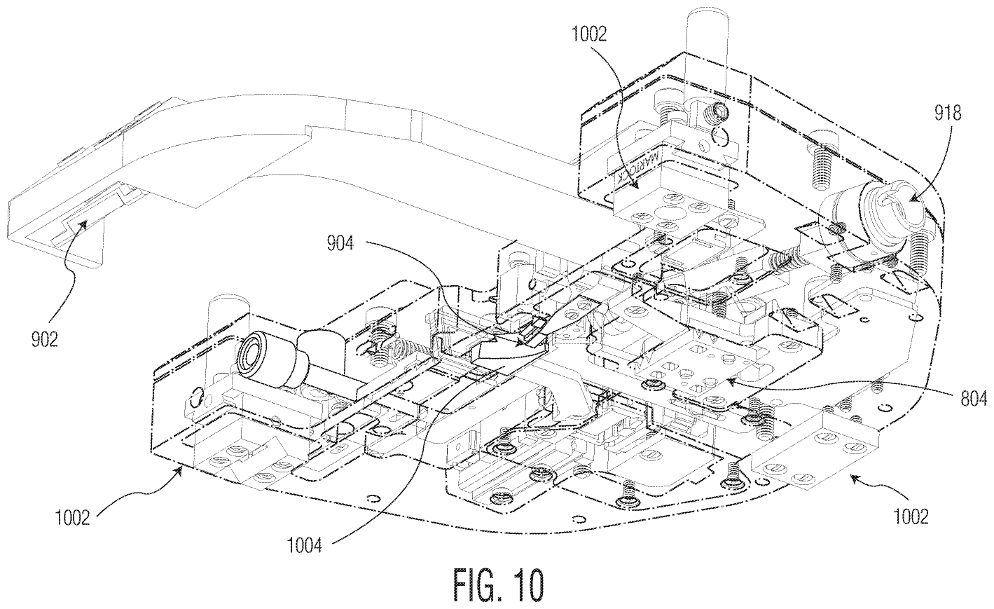

FIG. 10 is a bottom oblique view of the AFM head, showing how the ODC puck 804 is exposed on the bottom of the head. FIG. 10 shows three AFM head support feet 1002, the fiber coupled laser connection point 918, the ODC puck 804, a parabolic mirror 1004, the front gimbaled steering mirror 902, and the cantilever and tip location 904. When the AFM head is removed from the system, the ODC puck 804 stays with the head.

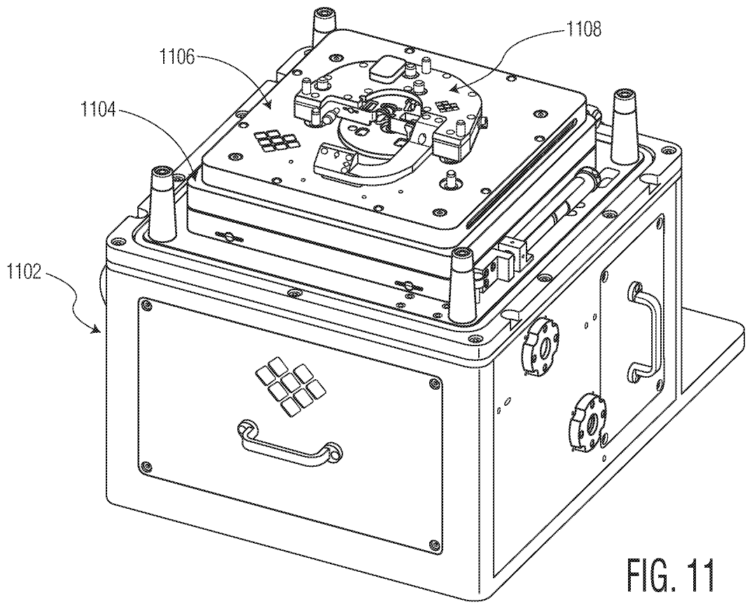

FIG. 11 shows a simplified view of the complete AFM (again, a system designed for photo-induced force microscopy). FIG. 11 shows a bottom frame and optics 1102, an X-Y translation stage 1104, a scanner 1106 and the AFM head 1108 with integrated ODC system. The frame 1102, which supports the microscope, also houses various optical components under the scanner and head. The translation stage provides a few millimeters of coarse X and Y position to adjust the position of the sample relative to the AFM head. The scanner provides piezo-controlled X, Y, and Z motion for scanning images and precisely positioning the sample relative to the AFM head with nanometer-scale precision.

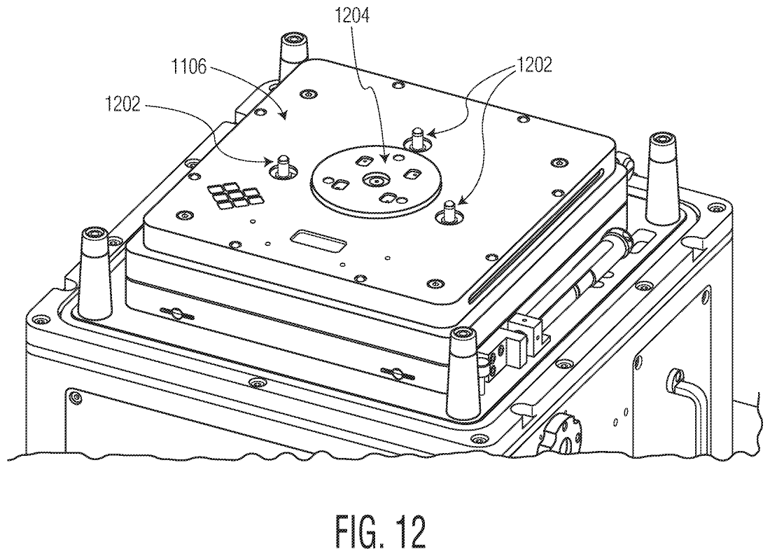

FIG. 12 shows a close up view of the top of the scanner 1106 with the AFM head 1108 removed. Three jack screws 1202 support the head and provide for coarse Z positioning of the head relative to the sample. These are used for coarse approach of the AFM tip to the sample; final approach is under piezo control. The round scanner platform 1204 is where the sample is mounted. The ODC puck 804 also sticks to the sample platform magnetically when the head is lowered onto the sample

When the ODC puck 804 initially sticks to the sample platform 1204, its position is within a fraction of a millimeter from proper position under the sensor. Its position needs only to be finely adjusted to zero the sensor in X and Y before scanning. This fine adjustment of the spherical mirror's position under the sensor is accomplished by a series of motions of the sample platform relative to the head, wherein the bumpers are used to push the puck to the desired position and then back off to a non-contact position for scanning. The sensor T-B and L-R signals are used as feedback while zeroing the mirror position.

The backlash intentionally designed into the pusher system requires that a specialized algorithm be used to zero the sensor in X and Y. While many variants of the algorithm can be devised, one approach is summarized here:

One time only: measure backlash (clearance) between push rods and bumpers in both X and Y
Iterative process of “bumping” and checking position of spherical mirror

Each time AFM tip is moved to a new position on the sample:
1. Move sample to target position under tip; record sample position
2. Move stage further in both X and Y to move puck to target position, taking into account known backlash (clearance)
3. Move sample back to target position under tip
4. Check ODC range centering
5. If ODC not sufficiently well centered, iterate above procedure until centered in both X and Y
6. Scan sample and acquire images, etc.

The above algorithm assumes that the sample positioner has its own precise position control system. For instance, by using a closed-loop sample positioning system with highly precise linear encoders for the X and Y motion of the stages that dictate the sample position. The sample scanner is in turn mounted on these sample positioning stages, which are used for coarse sample positioning.

Note that measurement of the backlash needs to be done only once since its value remains fixed as long as the same puck is used. If the puck is replaced, it is necessary to repeat the backlash measurement procedure and update the control system with the newly measured backlash values.

For small scans, it may be desirable to adjust the focus of the sensor for maximum sensitivity, resulting in minimum dynamic range. For larger scans, the scan motion may exceed the sensor's dynamic range resulting in clipping of the sensor output. When this occurs, it may be desirable to adjust the focusing lens in the sensor for reduced sensitivity and larger dynamic range. Alternatively, the sensor may be left at maximum sensitivity, but its output can be used only within the part of the scan range which is not subject to clipping of the sensor output.

Based on the detailed descriptions above, the following is a summary of the steps needed to initialize and use the sensor for drift correction in accordance with an embodiment of the invention:
1. Place the AFM head down on AFM base (puck automatically sticks down to sample platform via magnets integrated into puck).
2. Move AFM tip to desired target spot on sample; record target position of stages.
3. Move magnetic mirror holder (puck) via a series of stage motions so that the ODC sensor is in center of it dynamic range at target position. Head pushes puck around via push rods in head contacting bumpers on puck).
4. Manually adjust ODC focus (if sample thickness different than previous).
5. Return tip position to target position on sample (ODC push rods no longer contacting puck bumpers).
6. Scan image.
7. Track and correct drift using ODC X and Y position signals.

As noted in the description above, it may be necessary to adjust the sensor focus each time a sample with a different thickness is used, because the head is raised and lowered to accommodate the change in sample thickness. The manual adjustment scheme described above provides for this capability. If the sample thickness change exceeds the adjustment range of the adjuster, spacers may be added or removed between the puck and the sample platform. Ideally, these spacers are magnetically attached to the platform and puck, and allow for sliding motion of the puck relative to the sample platform as needed to adjust the mirror X-Y position under the sensor.

While the descriptions here indicate a single spherical mirror attached to the sample platform, an alternative is to use an array of mirrors. Doing so limits the amount of travel required to bring one of the mirrors into the correct position under the sensor for zeroing. The maximum adjustment distance needed is equal to the mirror pitch, provided the array is large enough to cover the entire desired sample positioning range.

Use of the sensor to make drift corrections in an AFM is as follows: Assuming the laser is initially position at the center of the quadrant photodiode, T-B and L-R are zeroed. As the system is subject to drift, these signals vary with time according to the magnitude of the tip-sample drift in their respective detection directions. T-B and L-R thus become error signals in a drift correction algorithm. In the absence of sample scanning, correcting for drift is particularly simple—a closed loop servo system is used to move the sample scanner (and possibly also the stages if large corrections are needed) to hold the sensor output fixed at a target value as time passes and drift occurs. In doing so, the AFM tip position is held fixed over a target position on the sample (except for a tiny amount of drift that may occur between the sensor elements and the sample on the scanner and tip in the head).

Correcting for drift while scanning images with the AFM requires a more complex algorithm. The simplest approach is to make drift corrections between images, holding the correction values fixed during actual scanning. This allows a series of images to be taken over an extended period of time while ensuring that the starting position of each scan is the same (provided drift is removed from the image starting point). While this approach provides a great deal of benefit, in cases where the scan speed is slow, scanning a single image may take a minute or more, and it may be desirable to correct for drift while an image is being taken.

Correction of drift during scanning requires that the sensor target output at various points in the image is known so that a proper error signal can be generated for the closed loop servo used to correct for the drift. In the fast scan (X) direction, this is straightforward, since the scanner returns to the same X positions with each scan line. For example, a specified point, such as the beginning of the line or the center of the line, can be used as the comparison point with each scan line. If the sensor output is recorded at the appropriate X position before the start of the image (or during the first scan line or first few scan lines), this value can be used to calculate the X error for the remaining scan lines in the image.

In the slow scanning (Y) direction, the target value is different for each scan line. One approach would be to move the scanner along Y before taking the image, and recording the target Y sensor values for each line (or at several distinct Y values) before scanning. Target Y values for each line during scanning can then be generated from a look up table, either a complete one with all values stored beforehand, or by interpolation based on a limited number of Y values stored before scanning.

A typical AFM is capable of rotating the scan direction relative to the fixed axes of the scanner and sensor. When the scan is rotated, both axes of the sensor will see fast motion. One strategy for drift correction in the case of rotated scans would be to sample the sensor output on both axes at a particular point in each scan line, such as the beginning, middle, or end (the choice of point is arbitrary). By moving the scanner along the trajectory of these points prior to scanning, the target sensor values can be established for the drift correction system to lock to during scanning. For example, if the strategy is to sample the sensor at the middle of each scan line, then moving the scanner along a line that follows what will be the middle of the scan lines prior to imaging will allow recording the target values for these points during later imaging. By comparing the value at the center of each scan line for both sensor axes to the stored target value, an error value corresponding to thermal drift can be derived, and a servo control loop can apply a correction to the scan position to counter the drift while scanning. As with nonrotated scans, a single recorded list of target values taken at a particular point in time can be used to correct for drift for a long period of time and through many subsequent images.

The noise level of the sensor (and therefore the overall positioning precision of the closed-loop drift correction system) is affected by the bandwidth of the sensor. To minimize noise level and provide the most precise control, the bandwidth may be reduced, either by analog filtering of the sensor output, or by digital means (such as digital filtering or averaging a number of subsequent measurements over a period of time). If the time constant of such filtering is long enough to affect the sensor readings while dynamically scanning, it is important that the history of the scanner motion prior to taking sensor measurements is identical or otherwise corrected to ensure that scanner history is not affecting the behavior of the closed-loop system. For example, for X correction, if a measurement is always made at the beginning of each scan line (including the initial measurement of the target value), then the history of X motion is identical in all cases. For Y correction, a similar precaution may be appropriate—making sure that the history of Y motion prior to measurement is identical for each measurement for the duration of at least a few time constants.

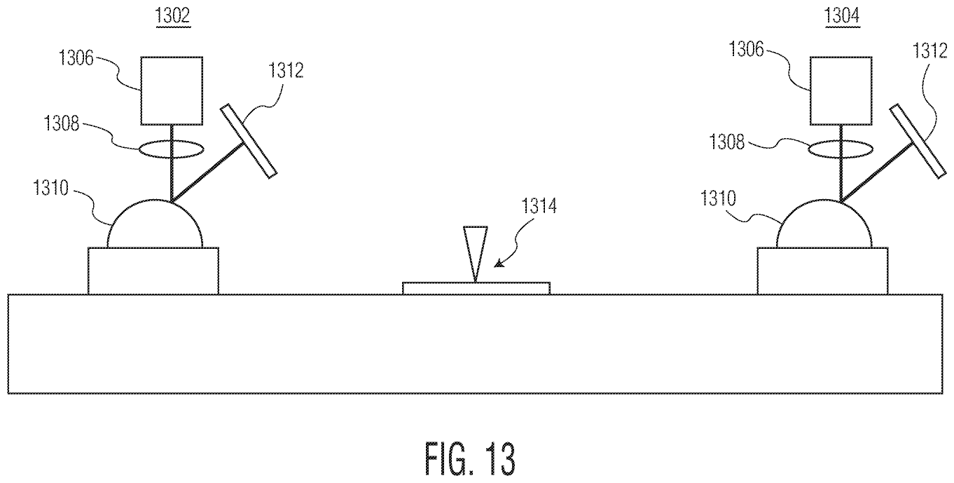

While all of the descriptions in this disclosure refer to a system having a single optical drift sensor for sensing X- and Y-motion, or two single axis sensors for detecting X- and Y-motion separately, a shortcoming of such systems is that they cannot correct for drift occurring between the sensor and the sample position (i.e., the point of interest). A closed loop system as described above counteracts drift at the location of the sensor itself. A more elaborate system can improve this situation. For example, as shown in FIG. 13, by placing two optical drift sensors 1302 and 1304 (each with at least a light source 1306, lens 1308, a mirror 1310 (e.g., convex reflector) and a detector 1312) close to, but on opposite sides of the sample location (sample and probe tip location or the point of interest) 1314 on a scanning stage 1316, both common mode and differential mode drift of the two sensors can be measured. The common mode drift (measured by taking the average signal of both sensors) provides a good representation of the actual drift at the point centered between the two sensors (i.e., the sample location), while the differential drift indicates expansion or contraction occurring between the two sensors. More generally, if multiple sensors are placed at various locations relative to the point of interest, a linear combination of the sensor outputs can be used to estimate the drift at the point of interest to first order. To the extent that drift is nonlinear (for example, caused by nonuniform temperature in the vicinity of the sensors and point of interest), a higher order error will be present, which cannot be easily corrected. Nonetheless, elimination of linear drift errors can be highly effective, improving the ability of the system to correct for thermal drift at the point of interest by an order of magnitude or more.

It should be noted that while this drift correction sensor was developed specifically to correct for drift occurring in scanning probe microscopes, embodiments of the invention can be applied to any system at any length scale where the ability to accurately sense motion over a limited range with great sensitivity is desired. For example, it could be used as part of a drift correction system for optical or e-beam lithography systems, where nm-scale drifts can result in loss of alignment of lithographic features. It could also be used to correct for drift in micropositioning systems used for metrology, such as a critical-dimension scanning electron microscope (CD-SEM), or a mask defect inspection system as used for photomasks in the lithography industry. While these are a few limited examples, the range of applications where motion sensing is used is virtually limitless

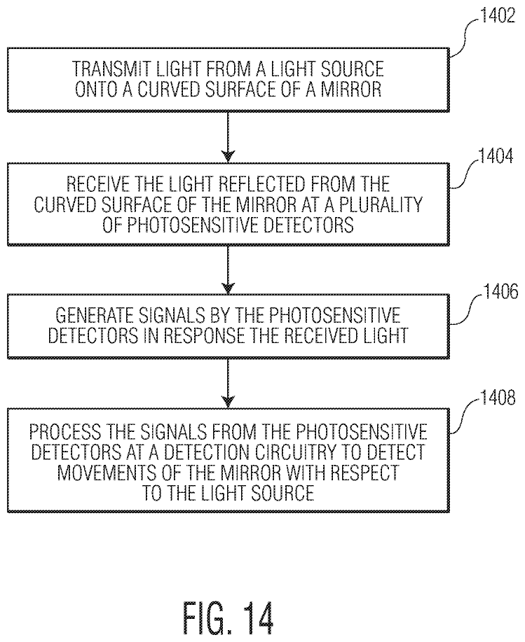

A method for optical drift correction in accordance with an embodiment of the invention is now described with reference to the process flow diagram of FIG. 14. At block 1402, light from a light source is transmitted onto a curved surface of a mirror. At block 1404, the light reflected from the curved surface of the mirror is received at a plurality of photosensitive detectors. At block 1406, signals are generated by the photosensitive detectors in response the received light. At block 1408, the signals from the photosensitive sensors are processed at a detection circuitry to detect movements of the mirror with respect to the light source. At block 1408, the movements of the mirror are corrected by appropriately moving the mirror using a mechanism, such as an X-Y scanning mechanism.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, at least portions of the disclose embodiments can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. An optical drift correction system comprising:
a mirror with a curved surface;
a light source positioned to transmit light onto the curved surface of the mirror;
a plurality of photosensitive detectors positioned to receive the light reflected from the curved surface of the mirror; and
a detection circuitry electrically connected to the photosensitive detectors to process signals from the photosensitive detectors to detect movements of the mirror with respect to the light source.

2. The system of claim 1, wherein the curved surface of the mirror is a convex surface or a concave surface.

3. The system of claim 1, wherein the mirror is a spherical mirror, an aspheric reflector or a convex parabolic reflector to detect two-dimensional drifts.

4. The system of claim 1, wherein the mirror is a convex parabolic reflector.

5. The system of claim 1, further comprising a focusing lens positioned to focus the light toward the curved surface of the mirror.

6. The system of claim 5, wherein the focusing lens is adjustable with respect to the distance from the curved surface of the mirror.

7. The system of claim 1, wherein the mirror is a cylindrical mirror to detect one-dimensional drifts along a first axis.

8. The system of claim 7, further comprising a second cylindrical mirror and a second plurality of photosensitive detectors to detect drifts along herein the mirror is a cylindrical mirror to detect one-dimensional drifts along a second axis that is perpendicular to the first axis.

9. The system of claim 1, further comprising a beam splitter positioned to split the light from the light source to the curved surface of the mirror to cause normal reflection and to transmit the reflected light to the plurality of photosensitive detectors.

10. The system of claim 9, further comprising a polarization film and half-wave plate positioned between the light source and the beam splitter and a quarter-wave plate positioned between the beam splitter and the curved surface of the mirror.

11. The system of claim 1, wherein the light source is a radio frequency modulated laser diode, a super-luminescent diode or a fiber-coupled light source.

12. The system of claim 1, wherein the mirror and the plurality of photosensitive detectors are part of a first optical drift correction sensor, wherein the system comprises a second drift correction sensor that includes a second mirror with a curved surface and a second plurality of photosensitive detectors, and wherein the detection circuitry is configured to use a mathematical combination of outputs from the first and second drift correction sensors to calculate drift.

13. The system of claim 1, wherein the mirror is attached to a scanning stage of an atomic force microscope.

14. An atomic force microscope comprising:
a cantilever with a tip to engage a sample;
a scanner platform to place the sample; and
an optical drift correction system coupled to the scanner platform, the optical drift correction system comprising:
a mirror with a curved surface;
a plurality of photosensitive detectors positioned to receive light reflected from the curved surface of the mirror; and
a detection circuitry electrically connected to the photosensitive detectors to process signals from the photosensitive detectors to detect movements of the mirror.

15. The atomic force microscope of claim 14, further comprising a plurality of pushers fixed to a frame of the optical drift correction system mounted in the AFM head, and a puck to which the curved mirror is fixed, the puck being slideably coupled to the sample scanner, and the pushers being positioned between bumpers on the puck so that the sample can be scanned over a limited range without contacting the bumpers and the puck can be slid by the bumpers to properly position the mirror under the optical beam of the drift correction system.

16. A method for optical drift correction, the method comprising:
transmitting light from a light source onto a curved surface of a mirror;
receiving the light reflected from the curved surface of the mirror at a plurality of photosensitive detectors;
generating signals by the photosensitive detectors in response the received light; and
processing the signals from the photosensitive detectors at a detection circuitry to detect movements of the mirror with respect to the light source.
